(19) United States
(12) Patent Application Publication
(10) Pub. No.: US 2012/0190244 A1
(43) Pub. Date: Jul. 26, 2012

(54) ELECTRICAL CONNECTOR

(76) Inventors: YU CHENG, Shanghai (CN); Yongfeng Ma, Shanghai (CN); Huibin Li, Shanghai (CN)

(21) Appl. No.: 13/354,909

(22) Filed: Jan. 20, 2012

(30) Foreign Application Priority Data
Jan. 20, 2011 (CN) 201120021700.0

(51) Int. Cl. H01R 24/00

(52) U.S. Cl. 439/630

(57) ABSTRACT

An electrical connector capable of saving mounting space while meeting its functional requirement to connect and secure an electronic module card with a printed circuit board. The electrical connector having an insulative body, a U-shaped groove, and a strap-like locking member. The insulative body includes an electronic module card receiving slot running along the longitudinal direction thereof. The U-shaped grove is formed in the insulative body and includes a first receiving section on a first side of the slot, a second receiving section disposed under the slot, and a third receiving section on a second side of the slot. The strap-like locking member includes a first end adapted to pass through the receiving sections and a second end adapted to connect together with the first end.

### CROSS-REFERENCE TO RELATED APPLICATION

This application claims the benefit of the filing date under 35 U.S.C. §19(a)-(d) of Chinese Patent Application No. 201.120021700.0, filed on Jan. 20, 2011.

### FIELD OF INVENTION

The present invention relates to an electrical connector and, more particularly, to a electrical connector for connecting an electronic module card to a circuit board.

### BACKGROUND

In personal computers and other electronic devices, electrical connectors are commonly used for connecting an electronic module card, such as dual-inline-memory-modules (DIMM) card, to a printed circuit board (PCB) so as to complete both electrical connection and mechanical connection between the electronic module card and the PCB.

As shown in FIG. 1, generally, such type of electrical connector includes an insulative body 1 of rectangular parallelepiped shape provided with a slot (now shown) running along a longitudinal direction thereof for inserting an electronic module card, such as a DIMM card, a pair of stoppers 20 disposed at two ends in the longitudinal direction of the insulative body respectively for restricting displacement of the electronic module card in the longitudinal direction and in a width direction of the electrical connector. Further, in order to prevent electronic module card from moving from the slot in a vertical direction, the electrical connector further includes snap latches 30 combined with the pair of stoppers 20 for locking the electronic module card in the insulative body 10. As shown in FIG. 1, the latches 30 can rotate about a horizontal axis in the insulative body 10 such that when the electronic module card is inserted in the slot of the insulative body 10, the latches 30 are in a position indicated by solid lines in FIG. 1, and when the electronic module card is withdrawn from the slot, the latches 30 are in a position indicated by dashed lines in FIG. 1.

However, with the above electrical connector, as shown in FIG. 1, for the purpose of inserting and withdrawing the card smoothly, when the electrical connector is mounted on the circuit board, additional spaces A on the outside of the two ends of the electrical connector are needed so that the latches 30 are able to open outward. When there are a large amount of such electrical connectors on the circuit board, the additional spaces are unfavorable in saving mounting space and meeting the requirement of microminiaturization of electronic products.

Further, with the above electrical connector, the latches 30 and the insulative body 10 are fixedly connected with each other. Therefore, when the latches 30 are damaged, it is difficult to replace them, which will adversely affect the use of the electrical connector.

### SUMMARY

It is an object of the invention, among others, to provide an electrical connector with a card locking mechanism that is cost effective and capable of saving mounting space.

The electrical connector having insulative body, a U-shaped groove, and a strap-like locking member. The insulative body includes an electronic module card receiving slot running along the longitudinal direction thereof. The U-shaped groove is formed in the insulative body and includes a first receiving section on a first side of the slot, a second receiving section disposed under the slot, and a third receiving section on a second side of the slot. The strap-like locking member includes a first end adapted to pass through the receiving sections and a second end adapted to connect together with the first end.

### BRIEF DESCRIPTION OF THE DRAWINGS

The objects, features and advantages of the invention will become more apparent by describing in detail embodiments thereof with reference to the accompanying drawings, in which:

FIG. 1 is a side view of a known electrical connector;

FIG. 2 is a perspective view of an electrical connector according to the invention;

FIG. 3A is a perspective view showing a first assembly step for connecting an electronic module card with a circuit board using the electrical connector shown in FIG. 2;

FIG. 3B is a perspective view showing a second assembly step for connecting an electronic module card with a circuit board using the electrical connector shown in FIG. 2;

FIG. 3C is a perspective view showing a third assembly step for connecting an electronic module card with a circuit board using the electrical connector shown in FIG. 2;

FIG. 3D is a perspective view showing a fourth assembly step for connecting an electronic module card with a circuit board using the electrical connector shown in FIG. 2;

FIG. 4 is a bottom perspective view showing the electronic module card and the circuit board connected by the electrical connector shown in FIG. 2; and

FIG. 5 is a an enlarged perspective view of the “B” portion in FIG. 4.

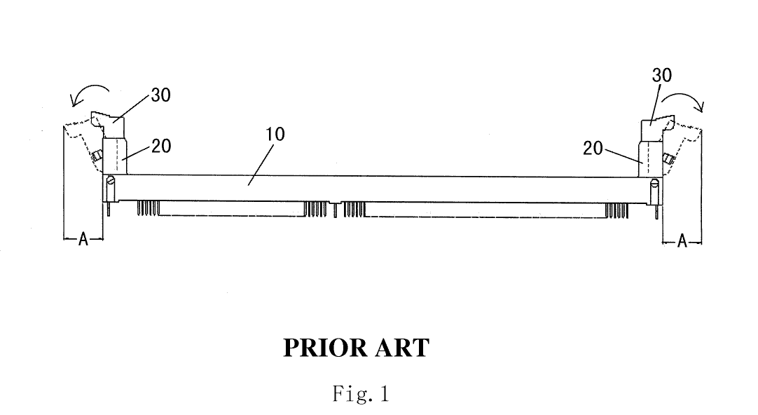

### DETAILED DESCRIPTION OF EMBODIMENT(S)

The embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

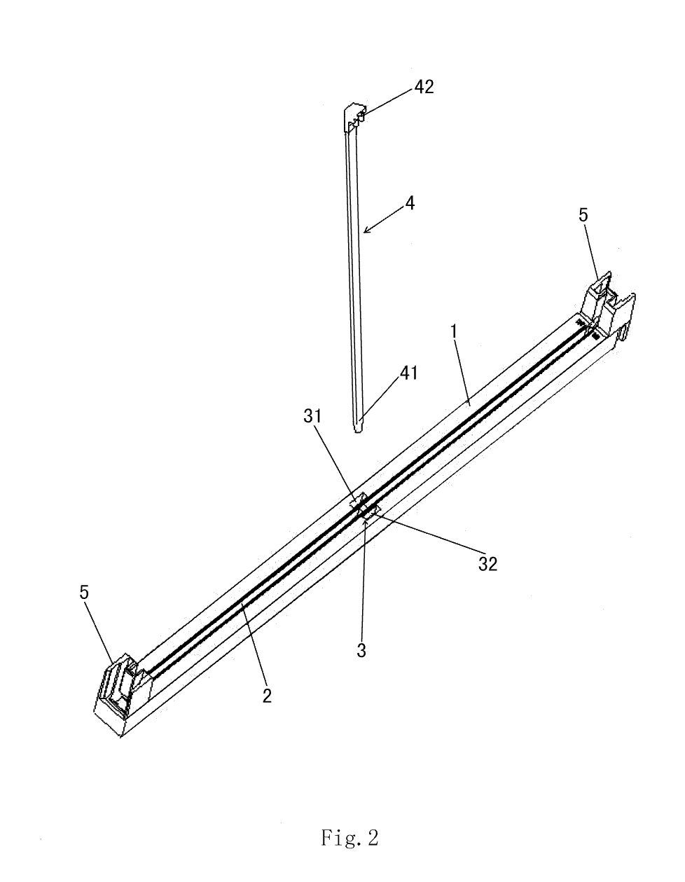

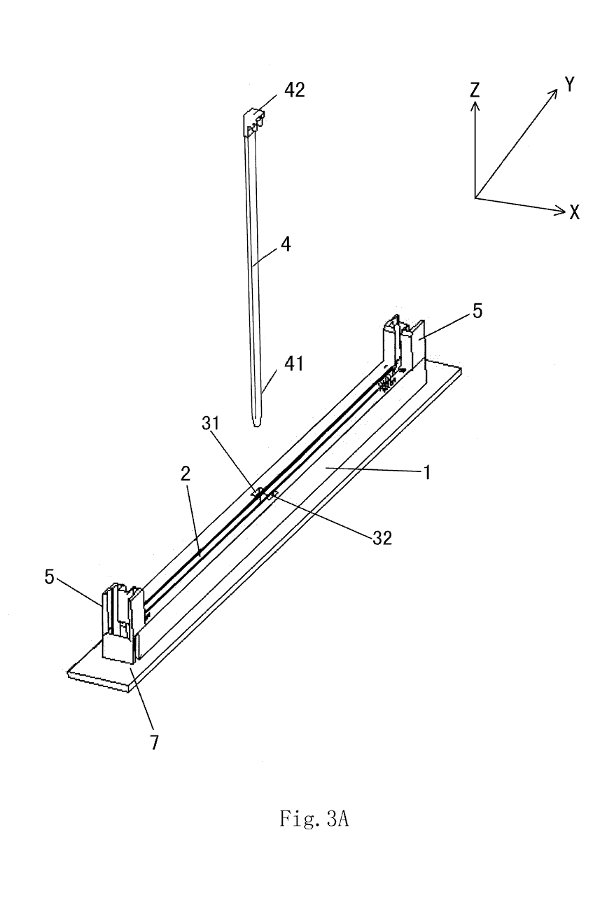

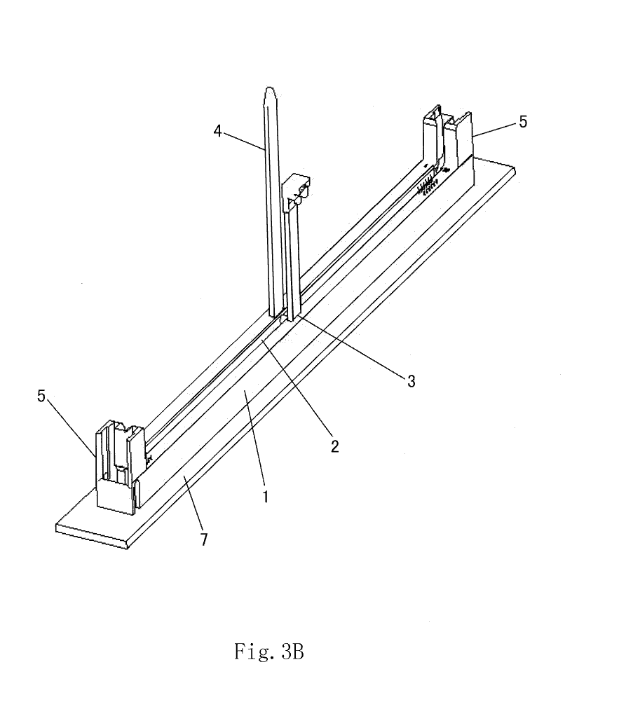

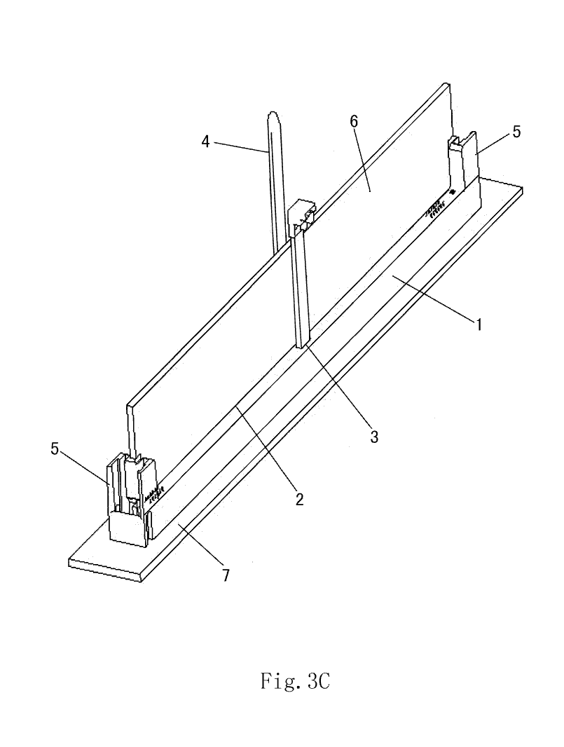

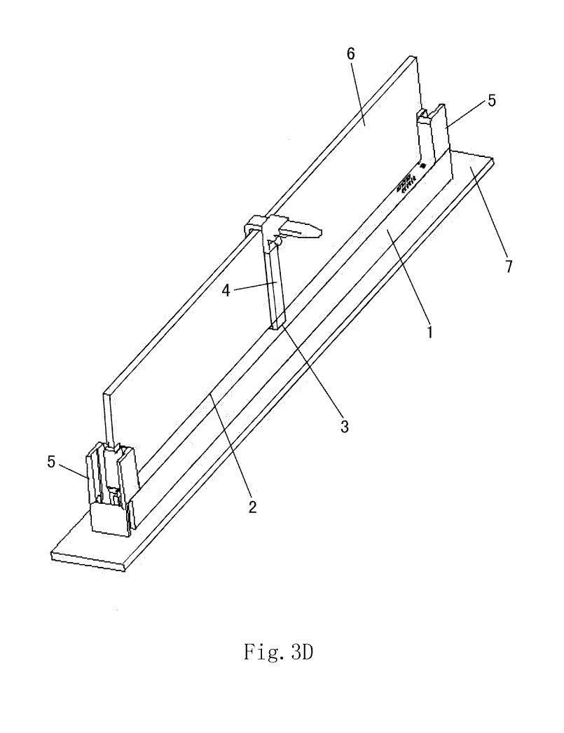

As shown in FIG. 2, an electrical connector includes an insulative body 1 of rectangular parallelepiped shape. On an upper surface of the insulative body 1 of rectangular parallelepiped shape, a central slot 2 is formed running along the longitudinal direction of the insulative body 1 for inserting an electronic module card 6 (hereinafter referred to as a card), such as a DIMM card (please also refer to FIGS. 3C-3D and FIG. 4), therein. There are a pair of stoppers 5 disposed at two opposite ends of the insulative body 1 in the longitudinal direction thereof, for restricting displacement of the card 6 in the longitudinal direction Y and in the transverse direction X of the insulative body 1. In order to prevent the card 6 from releasing from the slot 2 in a vertical direction Z of the insulative card 1, the electrical connector of the shown embodiment further includes a card locking mechanism for locking the card 6 in the insulative body 1.

As shown in FIG. 2, the card locking mechanism includes a U-shaped groove 3 formed in the insulative body 1 and a strap-like locking member 4. The U-shaped groove 3 is disposed substantially in the middle of the insulative body 1 in the longitudinal direction thereof for stably locking the card. The U-shaped groove 3 includes a first receiving section 31 on a first side of the slot 2, a second receiving section (not shown) under the slot 2, and a third receiving section 32 on the other side of the slot 2. The second receiving section (not shown) under the slot 2 connected the first receiving section 31 and the third receiving section 32. The strap-like locking member 4 may be made from suitable flexible material such as plastic, rope, fabrics and the like. A first end 41 of the strap-like locking member 4 is adapted to enter the first receiving section 31 of the U-shaped groove 3, run through the second receiving section of the U-shaped groove 3 and finally exit from the third receiving section 32. When the card 6 is inserted into the slot 2, the first end 41 and the second end 42 of the strap-like locking member 4 are adapted to connect with each other to form a ring-like member thr surrounding the card 6 in order to secure the card 6 in the slot 2.

FIGS. 3A-3D are perspective views showing assembly procedures for connecting an electronic module card 6 with a circuit board 7 by the electrical connector shown in FIG. 2. Figure As shown in FIG. 3A, the strap-like locking member 4 enters the U-shaped groove 3, in which the insulative body 1 of the electrical connector has connected to the circuit board 7. FIG. 3B shows the strap-like locking member 4 has passed through the U-shaped groove 3, while FIG. 3C shows the card being is inserted in the slot 2 of the insulative body 1 of the electrical connector. Finally, FIG. 3D shows the first end 41 and the second end 42 of the strap-like locking member 4 connected together and securing the card 6 in the slot 2.

According to a shown embodiment, a first engaging mechanism is positioned at the first end 41 of the strap-like locking member 4 and a second engaging mechanism is provided at the second end 42 of the strap-like locking member 4. The second engaging mechanism is adapted to releasably engage with the first engaging mechanism so as to connect the first end 41 and the second end 42 of the strap-like locking member 4 together. For example, various quick connecting such as snap fastener, adhesive connection, belt fastener and the like can be used between the first engaging means and the second engaging means. The first end 41 and the second end 42 of the strap-like locking member 4 may even tied to each other directly. Further, there may be a plurality of the first engaging mechanism, so that when the second engaging mechanism engages with different ones of the plurality of the first engaging mechanisms, the strap-like locking member 4 is adapted to lock cards having differing heights. Alternatively, there may be a plurality of the second engaging mechanism, so that when the first engaging mechanism engages with different ones of the plurality of the second engaging mechanisms, the strap-like locking member 4 is adapted to lock cards of differing heights. Alternatively, both of the first engaging mechanism and the second engaging mechanism can be plural.

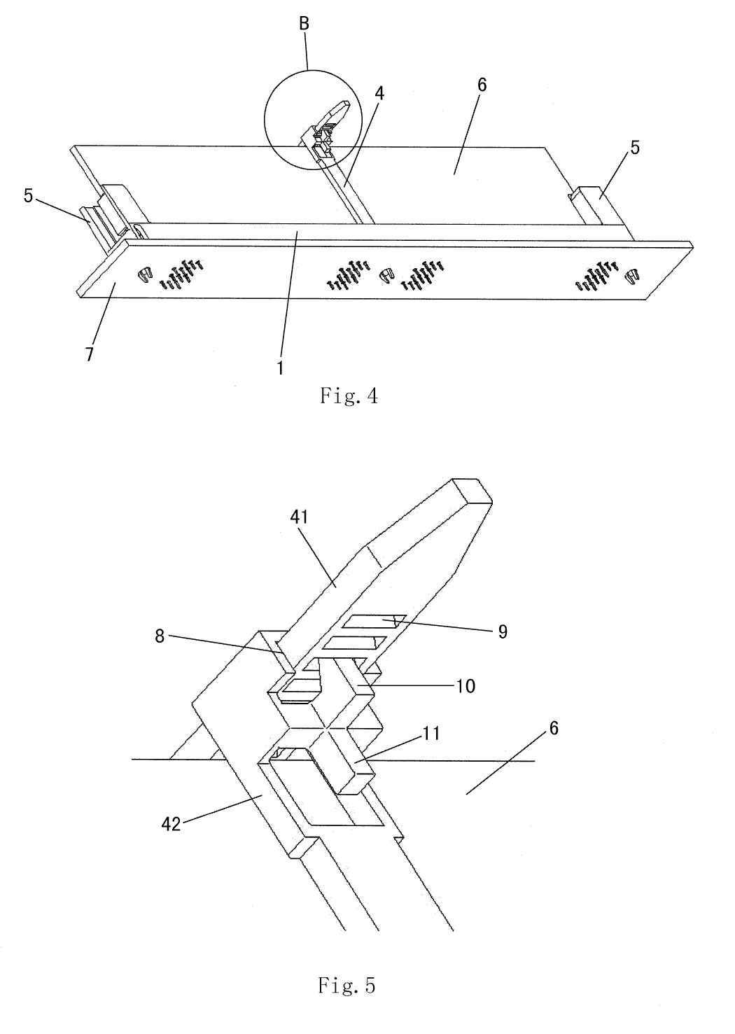

FIGS. 4 and 5 shows one embodiment of a connection between the first end 41 and the second end 42 of the strap-like locking member 4 according to the invention. The second end 42 of the strap-like locking member 4 is provided with a guide 8. The first end 41 of the strap-like locking member 4 is adapted to pass through the guide 8 so as to couple with the second end 42. Further, a plurality of catch receiving passageways 9 are formed in the first end 41 of the strap-like locking member 4, and a catch 10 is formed at the second end 42 of the strap-like locking member 4. The catch 10 is positioned below the guide 8 and adapted to releasably engage one of the plurality of catch receiving passageways 9. In addition, an elastic grip member 11 may be provided below the catch 10 so that when the grip member 11 is pressed down toward the card 6, the catch 10 can rotate downward and release from the catch receiving passageway 9. After that, the strap-like locking member 4 is able to move freely forward and backward in the guide 8 so as to adjust the tightness for locking the card by the strap-like locking member 4. On the other hand, if the grip member 11 is released, the catch 10 can move back elastically and engage the catch receiving passageway 9 automatically so that the strap-like locking member 4 can not move and the card 6 is locked in the slot 2.

As described above, according to the electrical connector of the invention, as compared with the prior art, the locking mechanism does not occupy the additional mounting spaces outside the connector, so that it is favorable for the miniaturization of electronic products. The manufacture cost of the card locking mechanism is far less than the snap latches of the prior art. The strap-like locking member is releasably connected to the insulative body of the electrical connector and is easy for replacement.

Although several embodiments have been shown and described, it would be appreciated by those skilled in the art that various changes or modifications may be made in these embodiments without departing from the principles and spirit of the disclosure, the scope of which is defined in the claims and their equivalents.

As used herein, an element or step recited in the singular form and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, the wording “comprising” does not exclude additional elements or steps.

What is claimed is:

1. An electrical connector, comprising:
an insulative body having an electronic module card receiving slot running between two opposite ends thereof,
a receiving groove formed in the insulative body and having a first receiving section on a first side of the electronic module card receiving slot, a second receiving section disposed under the electronic module card receiving slot, and a third receiving section on a second side of the electronic module card receiving slot, and
a strap-like locking member having a first end adapted to pass through the receiving sections and a second end adapted to connect together with the first end to form.

2. The electrical connector according to claim 1, wherein strap-like locking member is formed into a ring-like member when the first end and the second connect together.

3. The electrical connector according to claim 1, wherein the first end of the strap-like locking member includes a first engaging mechanism.

4. The electrical connector according to claim 3, wherein the second end of the strap-like locking member includes a second engaging mechanism that connects with the first engaging mechanism.

5. The electrical connector according to claim 4, wherein at least one first or second engaging mechanism includes a release mechanism to disconnect the first and second engaging mechanisms.

6. The electrical connector according to claim 1, wherein the second end of the strap-like locking member includes a guide formed therein.

7. The electrical connector according to claim 6, wherein the first end of the strap-like locking member is adapted to pass through the guide so as to couple with the second end of the strap-like locking member.

8. The electrical connector according to claim 6, wherein the first end of the strap-like locking member includes a catch receiving passageway positioned thereon.

9. The electrical connector according to claim 8, wherein the second end of the strap-like locking member includes a catch that releasably engages with the catch receiving passageway.

10. The electrical connector according to claim 9, wherein the second end of the strap-like locking member includes an elastic grip member that operates the catch.

11. The electrical connector according to claim 1, wherein the receiving groove is disposed substantially between opposite ends of the insulative body.

12. The electrical connector according to claim 1, further comprising a pair of stoppers disposed at opposite ends of the insulative body respectively and adapted to restrict lateral displacement of an electronic module card positioned in the electronic module card receiving slot.

13. The electrical connector according to claim 1, wherein the receiving groove is a U-shaped receiving passageway with the first and third receiving sections disposed on a top surface of the insulative body and extending into the second receiving section positioned under the electronic module card receiving slot.
